(19) United States
(12) Patent Application Publication
(10) Pub. No.: US 2017/0030315 A1
(43) Pub. Date: Feb. 2, 2017

(54) METHOD FOR MANUFACTURING INJECTION OPENINGS AND FUEL INJECTOR HAVING SUCH INJECTION OPENINGS

(71) Applicant: Robert Bosch GmbH, Stuttgart (DE)

(72) Inventor: Thorsten BAUER, Memmelsdorf (DE)

(21) Appl. No.: 15/302,253

(22) PCT Filed: Feb. 18, 2015
(86) PCT No.: PCT/EP2015/053374

§ 371 Date: Oct. 6, 2016

(30) Foreign Application Priority Data
Apr. 8, 2014 (DE) 10 2014 206 782.0

(51) Int. Cl. F02M 61/16; F02M 61/18

(52) U.S. Cl. CPC F02M 61/168; F02M 61/1806; F02M 61/1853; F02M 2200/03; F02M 2200/8069

(57) ABSTRACT

A method for manufacturing injection openings of a fuel injector, including: manufacturing a prechamber with the aid of a mechanical, cutting method, in particular with the aid of milling or drilling or with the aid of laser ablation, producing a radius at the transition of the prechamber between a prechamber wall and a prechamber base with the aid of a laser, and/or introducing grooves into the prechamber wall and/or the prechamber base, and manufacturing a spray hole in the prechamber base.

### FIELD OF THE INVENTION

The present invention relates to a method for manufacturing injection openings of a fuel injector and to a fuel injector having such injection openings.

### BACKGROUND INFORMATION

Different embodiments of fuel injectors having injection openings are believed to be understood from the related art. In the case of direct-injecting systems in particular, such injection openings frequently have a spray hole and a prechamber. Due to the provision of the prechambers, however, a cross section of a component is reduced, which results, in particular, in a deflection of the lines of force occurring when internal pressure (fuel pressure) is applied to the component. Furthermore, the provision of prechambers reduces a wall thickness between adjacent injection openings or to an outer wall of the fuel injector. This may then result in problems with regard to the mechanical strength. The prechambers of the injection openings for fuel injectors have been previously manufactured, for example, using a cutting method, in particular drilling. Alternatively, a manufacture of the injection openings with the aid of a laser would also be possible, the laser having the disadvantage, however, that only low material-removal rates are achievable as compared to mechanical material-removing methods. The spray hole is manufactured in a second step, non-cutting methods such as spark erosion and laser drilling also being used, in part. An edge results between the prechamber wall and the prechamber base, which results in a strong deflection of lines of identical stress in the component.

### SUMMARY OF THE INVENTION

The method according to the present invention for manufacturing injection openings of a fuel injector having the features described herein has the advantage over the related art in that injection openings may be manufactured to include prechambers which withstand greater loads, in particular higher fuel pressures, without an enlargement of wall thicknesses or the like being necessary therefor. In this case, the injection opening according to the present invention has a prechamber and the actual spray hole which, starting from the prechamber, injects the fuel into a combustion chamber or the like. The method according to the present invention includes the steps of manufacturing the prechamber with the aid of a mechanical, cutting method, in particular by milling or drilling, or with the aid of laser ablation. In addition, a radius is manufactured at a transition of the prechamber between a prechamber wall and a prechamber base with the aid of a laser. In addition, the spray hole is introduced into the prechamber base of the prechamber. According to the present invention, a, e.g., mechanically material-removing, method, which may remove a large amount of material in a short time, may therefore be combined with a laser method which, in particular, manufactures roundings at the transition between the prechamber wall and the prechamber base. The roundings have a radius R in such a way that the lines of identical stress are deflected less extremely, so that the injection opening according to the present invention withstands greater loads, in particular higher fuel pressures, without becoming damaged. Further, the method according to the present invention additionally or alternatively may include the introduction of grooves into the prechamber wall and/or the prechamber base for producing a radius at a transition of the prechamber. The groove or the grooves may therefore be provided independently of the provision of a radius at the transition of the prechamber and are also used for relieving material stress, so that greater loads on the prechamber due to pressures or the like are possible.

The further descriptions herein show refinements of the present invention.

The spray hole may also be manufactured with the aid of a laser. As a result, which may be both the radius in the transition area between the prechamber wall and the prechamber base, as well as the spray hole itself may be manufactured in one machining step. Further, the prechamber base may also be machined using the laser, in order to obtain a good surface. In this case, only a small material thickness is removed from the prechamber base.

According to one further embodiment of the present invention, grooves are introduced into the prechamber wall and/or the prechamber base with the aid of the laser. The grooves also have a positive effect on the distributions of stress in the component, so that a less extreme deflection of the distributions of stress occurs. The forces which may be absorbed by the component having the injection opening may also be increased as a result. The grooves in this case may be configured as completely circumferential grooves, which may be having an essentially U-shaped cross section.

Further, a second, smaller prechamber, which has a second radius at a transition area between the wall and the base of the second prechamber, may be introduced at the transition between the prechamber and the actual spray hole. Further, the second, smaller prechamber may also be provided with the aid of a laser.

The second radius at the transition between a wall area and a base area of the second prechamber may also be manufactured with the aid of a laser.

Furthermore, it may be provided to manufacture the prechamber in a first step with the aid of the mechanical, cutting method and then all further work to be performed using the laser is carried out in one setting.

The present invention further relates to a fuel injector including at least one injection opening, which has a prechamber and a spray hole. The prechamber has a radius at a transition between a prechamber wall and a prechamber base in order to deflect stress lines less extremely in the component including the injection opening.

Instead of the radius, a groove may be introduced into the prechamber wall and/or the prechamber base. Furthermore, a combination of the radius and the groove at the prechamber of the injection opening is also possible.

Further, one or multiple groove(s) may be provided in the prechamber wall and/or in the prechamber base, which may be completely circumferential. The grooves may be produced with the aid of a laser.

Further, a second prechamber, which has a second radius at a transition area between the wall and the base of the second prechamber, may be provided between the prechamber and the spray hole. The fuel injector further may include a valve housing, in which the injection opening is provided. Alternatively, the fuel injector includes a spray hole disk, in which at least one, which may be multiple injection openings is/are formed.

Exemplary embodiments of the present invention are described in detail in the following with reference to the accompanying drawing. In the drawing, identical or functionally identical parts are labeled using the same reference numerals.

### BRIEF DESCRIPTION OF THE DRAWINGS

FIG. 1 shows a schematic sectional view of a fuel injector according to a first exemplary embodiment of the present invention.

FIG. 2 shows a schematic sectional view of an injection opening from FIG. 1 during the manufacturing method.

FIG. 3 shows a schematic sectional view of the injection opening from FIG. 2 in the finished state.

FIG. 4 shows a schematic sectional view of an injection opening according to a second exemplary embodiment of the present invention.

FIG. 5 shows a schematic sectional view of an injection opening according to a third exemplary embodiment of the present invention.

FIG. 6 shows a schematic sectional view of an injection opening according to a fourth exemplary embodiment of the present invention.

### DETAILED DESCRIPTION

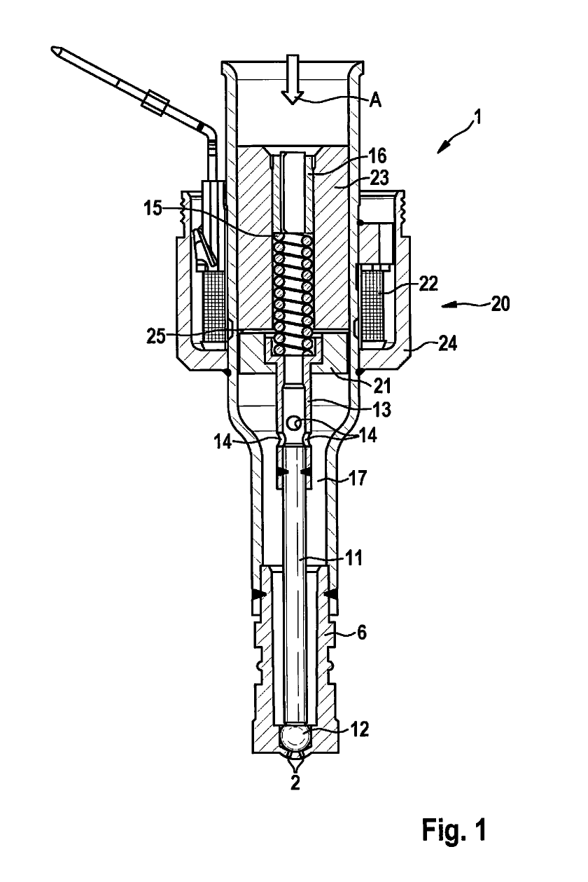

A fuel injector 1 according to a first exemplary embodiment of the present invention and a first method according to the present invention are described in detail in the following with reference to FIGS. 1 through 3.

FIG. 1 schematically shows a fuel injector 1, which includes multiple injection openings 2 in a valve housing 6. Fuel injector 1 includes a valve needle 11 including a ball 12, which unblocks and blocks injection openings 2 on a valve seat. Valve needle 11 is connected via an entraining element 13 to an armature 21 of a magnetic actuator 20. Magnetic actuator 20 further includes a coil 22, a pole core 23, and a magnetic pot 24. A working gap 25 is provided, in this case, between armature 21 and pole core 23 in the axial direction. Armature 21 is reset to the starting position shown in FIG. 1, which is the closed position of the fuel injector, in a known way with the aid of a restoring element 15. The restoring force of the restoring element may be defined with the aid of an adjusting sleeve 16.

Fuel is fed, as indicated by arrow A in FIG. 1, in the axial direction through adjusting sleeve 16 and hollow entraining element 13 into a space 17 in the area of valve needle 11. Passages 14 are provided in entraining element 13 for this purpose.

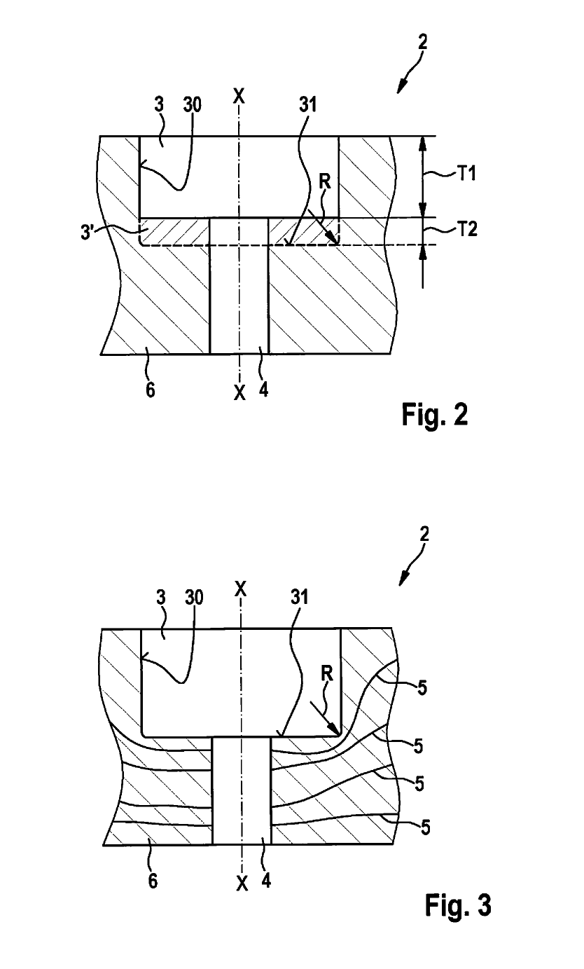

Injection opening 2 and its manufacture are schematically shown in FIGS. 2 and 3. FIG. 3 shows the finished state of injection opening 2, which includes a prechamber 3 and a spray hole 4. Prechamber 3 includes a prechamber wall 30 and a prechamber base 31. Prechamber wall 30 is configured essentially cylindrical and prechamber base 31 is perpendicular to axial direction X-X of injection opening 2. A transition area between the prechamber wall and prechamber base 31 is formed with the aid of a radius R. Radius R at the transition area between prechamber wall 30 and prechamber base 31 ensures that lines 5 of identical stress, which are plotted in FIG. 3, do not deviate too extremely, in particular in the area of the transition. Areas of sharp deflections of the lines of identical stress usually result in zones having locally high mechanical stress in different levels. A spacious deflection may infer a favorable state of stress. As is apparent from FIG. 3, lines 5 of identical stress each form curves having relatively large radii, also in the transition area having radius R, so that stress peaks in valve housing 6, which would occur in the case of an angular transition between the prechamber wall and the prechamber base, may be avoided according to the present invention.

FIG. 2 schematically shows the manufacture of injection opening 2. In a first step, prechamber 3 is manufactured to a depth Ti with the aid of a cutting tool, e.g., a drill or a milling cutter. The use of the cutting tool may be carried out in this case at a high rate of material removal. Alternatively, the entire prechamber may also be produced using a laser. In a next step, residual material which still remains and which is labeled with reference numeral 3′ in FIG. 2, is removed with the aid of a laser. In this case, material removal takes place on prechamber base 31. Simultaneously, radius R is produced at a transition area between prechamber wall 30 and prechamber base 31 with the aid of the laser. Therefore, a curved transition between prechamber wall 30 and prechamber base 31 is provided, which would not be present in this way if machining were carried out exclusively with the aid of a cutting tool. In a final step, spray hole 4 is then produced with the aid of the laser.

In the method according to the present invention, both a surface machining of prechamber base 31 and a manufacture of radius R at the transition area between the wall and the base, and spray hole 4 may therefore be manufactured with the aid of the laser.

Since a quantity of the material to be removed with the aid of the laser is relatively small, short total manufacturing times may be nevertheless achieved according to the present invention. Therefore, due to the idea according to the present invention, a functional value of the component may be improved in terms of increasing the load capacity under higher pressures, without causing notable cost increases in the manufacture of injection opening 2 due to the method according to the present invention. The skillful combination, according to the present invention, of material removal by cutting and laser ablation therefore provides for significant cost advantages in the manufacture, which provide great economic advantages, since the components are mass-produced parts.

Since arbitrary radii R at the transition area between prechamber wall 30 and prechamber base 31 are manufacturable with the aid of the laser, the method according to the present invention may also be carried out for highly diverse diameters of prechamber 3, each of which is adapted, for example, to different internal combustion engines of varying power or are adapted by different manufacturers.

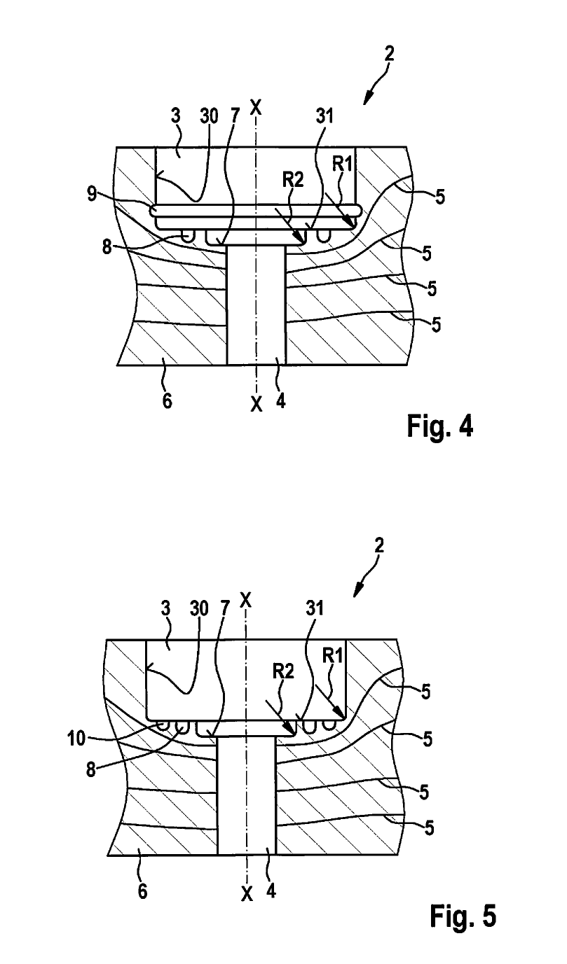

FIGS. 4 and 5 show further exemplary embodiments of the present invention. In FIG. 4, an additional, second prechamber 7 is formed, which was also manufactured with the aid of the laser, due to its low depth. In this case, a second radius R2 is formed at the transition between the wall and the base of second prechamber 7. This second radius is therefore adapted to the diameter of second prechamber 7 and is slightly smaller than radius R1 at first prechamber 3. In the exemplary embodiment shown in FIG. 4, a circumferential first groove 8 is furthermore provided in prechamber base 31 and a second circumferential groove 9 is formed in prechamber wall 30. These grooves 8, 9 ensure that a flux of force in valve housing 6 and, therefore, lines 5 of identical stress are forced to undergo a more spacious deflection around the transition area between the wall and the base. Additional grooves 8, 9 may also be manufactured with the aid of the laser and may be set up during the manufacture of spray hole 4.

In FIG. 5, a further alternative exemplary embodiment of the present invention is represented, no groove being provided in prechamber wall 30, although a first groove 8 and a second groove 10 are formed in prechamber base 31. The two grooves 8, 10, in turn, are provided to be circumferential, a depth of the grooves being different. In this exemplary embodiment, first groove 8 is deeper than second groove 10. Also as a result thereof, a more gentle deflection of lines 5 of identical stress in valve housing 6 is achieved (see FIG. 5). The two grooves 8, 10 in this case effectuate such a deflection of lines 5 of identical stress that material which is located between the two grooves 8, 10 does not need to be removed.

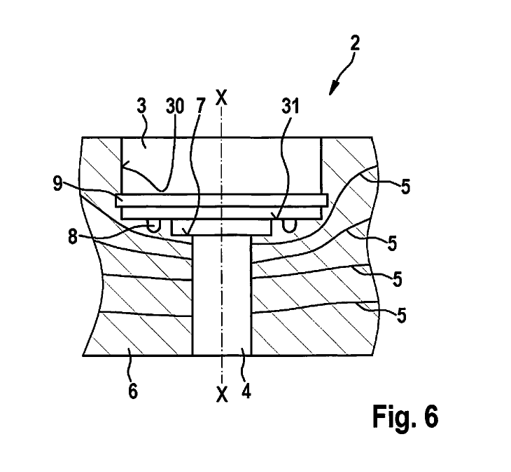

FIG. 6 shows a further alternative exemplary embodiment of the present invention, which does not include a radius at the transition between the wall and the base of the prechamber, but rather a corner. Instead of the radius, a circumferential first groove 8 is provided in prechamber base 31 and a second circumferential groove 9 is provided in prechamber wall 30.

Grooves 8, 9 are provided relatively close to the corners without a radius in this case, so that lines of identical stress are forced to undergo a spacious deflection around the corners or around the transition area between the wall and the base. Grooves 8, 9 may likewise be manufactured with the aid of a laser.

1-10. (canceled)

11. A method for manufacturing injection openings of a fuel injector, the method comprising:
producing a prechamber with the aid of a mechanical, cutting process or laser ablation;
producing a radius at a transition of the prechamber between a prechamber wall and a prechamber base with the aid of a laser, and/or introducing grooves into the prechamber wall, and/or the prechamber base; and
producing a spray hole in the prechamber base.

12. The method of claim 11, wherein the spray hole is manufactured with the aid of the laser.

13. The method of claim 11, wherein material removal is also carried out on the prechamber base during production of the radius at the prechamber.

14. The method of claim 11, wherein grooves are introduced into the prechamber wall and/or in the prechamber base with the aid of the laser.

15. The method of claim 14, wherein the grooves are introduced as circumferential grooves.

16. The method of claim 11, wherein a second prechamber is introduced at a transition area between the prechamber and the spray hole, a second radius being provided at the second prechamber at the transition area between the wall and the base.

17. A fuel injector for metering fuel, comprising:
at least one injection opening having a prechamber and a spray hole; and
at least one of:
a radius formed at the prechamber at a transition area between a prechamber wall and a prechamber base; and/
groove introduced into the prechamber wall and/or the prechamber base.

18. The fuel injector of claim 17, further comprising:
at least one groove, which is formed completely circumferential in the prechamber wall and/or in the prechamber base.

19. The fuel injector of claim 17, wherein a second prechamber at a transition between the first prechamber and the spray hole, a second radius being formed at a transition between a wall and a base of the second prechamber.

20. The fuel injector of claim 17, further comprising:
one of: (i) a valve housing, in which the injection opening is provided, and (ii) a spray hole disk, in which the injection opening is provided.

21. The method of claim 11, wherein the mechanical, cutting process includes milling or drilling.

22. The method of claim 11, wherein a second prechamber is introduced, in particular with the aid of a laser, at a transition area between the prechamber and the spray hole, a second radius being provided at the second prechamber at the transition area between the wall and the base.
